(19) United States
(12) Patent Application Publication
(10) Pub. No.: US 2024/0304076 A1
(43) Pub. Date: Sep. 12, 2024

(54) IMPROVEMENTS IN OR RELATING TO HAND DRYING SYSTEMS

(71) Applicant: DYSON TECHNOLOGY LIMITED, Wiltshire (GB)

(72) Inventors: Oliver James YOUNG, Bristol (GB); Kevin John SIMMONDS, Bath (GB); Jack Iain BRACKEN-LOBB, Bristol (GB)

(73) Assignee: Dyson Technology Limited, Wiltshire (GB)

(21) Appl. No.: 18/278,614

(22) PCT Filed: Feb. 17, 2022
(86) PCT No.: PCT/GB2022/050433

§ 371 Date: Aug. 23, 2023

(30) Foreign Application Priority Data
Feb. 26, 2021 (GB) 2102767.7
Feb. 26, 2021 (GB) 2102769.3
Feb. 26, 2021 (GB) 2102770.1
Feb. 26, 2021 (GB) 2102771.9
Feb. 26, 2021 (GB) 2102772.7
Feb. 26, 2021 (GB) 2102773.5
Feb. 26, 2021 (GB) 2102774.3
Feb. 26, 2021 (GB) 2102775.0

(51) Int. Cl. G08B 21/24; A47K 10/48

(52) U.S. Cl. CPC G08B 21/245; A47K 10/48

(57) ABSTRACT

A system including a hand dryer appliance including an electronic control system and a filter. The electronic control system is configured to monitor a filter loading parameter that is indicative of a loading level of the filter; generate a plurality of filter loading messages over time based on the monitored filter loading parameter, indicating the progressive loading of the filter, initiate a communications module to connect to a telecommunications network, and transmit the generated filter loading messages from the communications module to the telecommunications network.

### TECHNICAL FIELD

The invention relates to a hand dryer, as might be installed in a washroom of a business premises, for example, and to an information or communication system incorporating one or more such hand dryers.

### BACKGROUND

Commercial premises generally provide blown-air hand dryer systems in washrooms as a hygiene measure so that users of a washroom can dry their hands. Blown-air hand dryers are generally favoured from an environmental perspective since they eliminate paper towel waste and the laundry requirements inherent of the provision of fabric towels.

Some blown-air hand drying systems also incorporate a hand washing function, such as the ‘Airblade Tap’ as available from Dyson Limited.

Whichever form they take, blown-air hand drying systems need to be included in a suitable facilities management program in order that they can be maintained in an appropriate way. For example, all blown-air hand drying systems require regular cleaning, and many will also require periodic filter changes. Moreover, they will require mending or replacement in the event of a fault. Currently, such facilities management activities tend to be largely manually driven, involving inspections of the hand dryers by staff, appropriate cleaning, recording of faults and so on. Such programs are generally inefficient and error-prone.

There are some examples in the art which aim to improve the management of hand dryer systems by providing internet-enabled appliances that are able to communicate with a central computer system to share performance and configuration data and also to provide a graphical user interface to engage the user in some way, for example by providing targeted advertising content. Examples include US2016/0028838, WO2014/033427 and US2016/0256021. Despite the recent efforts to improve the way in which hand drying systems are operated, there are still may opportunities to optimise their functionality. It is against this background that the examples of the invention have been devised.

### SUMMARY OF THE INVENTION

According to a first aspect, embodiments of the invention provide a system comprising a hand dryer appliance comprising an electronic control system. The electronic control system is configured to generate an appliance data record, wherein the appliance data record is loaded with one or more appliance-specific data items including an appliance identification data item, initiate a communications module to connect to a telecommunications network, and transmit the appliance data record from the communications module.

Beneficially, therefore, in the system of the invention the hand dryer appliance is able to generate a data record itself through which means it can register its installation with its manufacturer or operator by sending that generated data record over a communications network such as the internet. This provides a technically more capable product which does not require user intervention to carry out a product registration process. Furthermore, by transmitting the generated data record to the manufacturer of the appliance, the manufacturer can gain a more reliable and complete understanding of where its products are distributed and where maintenance resources may be required.

Although in principle the data record may be generated and transmitted at any time, in one embodiment the electronic control system is configured to generate the appliance data record when external power is applied to the hand dryer appliance for the first-time following installation. This may be the case where the hand dryer appliance is fixed to its mountings, electrically connected to a mains electricity supply and activated, which can trigger the product registration process.

In one sense, the hand dryer appliance may provide information relating to its identity and other intrinsic properties that will assist its operator/manufacturer to logs its existence for future use. However, in an enhanced approach, the electronic control system is configured to request user data input at a user interface, wherein the user data input provides one or more user-generated data items, and load the user-generated data items into the appliance data record. Therefore, the electronic control system merges two types of data in this example: appliance-specific data which may be stored in the memory of the appliance ready for upload to the generated appliance data record, and also user-specific data which can be entered by an installation or maintenance engineer for example via a suitable user interface which may be integral with or remote from, but in communication with, the electronic control device. Such a measure can provide a more complete data record for the appliance.

The one or more appliance-specific data items may include one or more of: appliance serial number; time of initial power-up cycle; IP address, whereas the one or more user-generated data items may include a geographical location identifier of the appliance; a building identifier; and a washroom identifier.

The generated appliance data record may be transmitted by the communications module to one or both of an OEM computer system and a facilities management computer system.

In another aspect, embodiments of the invention provide a system comprising a hand dryer appliance comprising an electronic control system. The electronic control system is configured to monitor one or more performance metrics associated with the hand dryer appliance, identify that a component of the hand dryer appliance requires replacement based on the one or more monitored performance metrics, and, in response generate an electronic maintenance record including an indication of the component that requires replacement; initiate a communications module to connect to a telecommunications network; and transmit the appliance data record from the communications module to the telecommunications network.

Advantageously, this aspect of the invention supports a predictive maintenance approach for the hand dryer appliance which means that parts are ordered and replaced before they fail, which improves the efficiency of the process and avoids machine down-time.

Examples of what components may be monitored by way of this system are an electric motor of a blower unit of the hand dryer appliance and an air filter.

Where the component to be replaced is a filter, the electronic control system may be configured to monitor the progressive loading of the filter to determine if the filter requires replacement. This can be achieved by monitoring air pressure at a point upstream of the filter, or a reduction of air pressure at a point downstream of the filter. This objective can also be achieved by identifying when the operational motor speed and/or motor current draw is not within an expected operational parameter range.

Where the component to be replaced is an air flow motor, the electronic control system may be configured to identify that the air flow motor requires replacement when it detects that motor current draw is not within an expected operational parameter range.

In another aspect, embodiments of the invention provide a system comprising a hand dryer appliance comprising an electronic control system and a filter. The electronic control system is configured to monitor a filter loading parameter that is indicative of a loading level of the filter; generate a plurality of filter loading messages over time based on the monitored filter loading parameter, indicating the progressive loading of the filter, initiate a communications module to connect to a telecommunications network, and transmit the generated filter loading messages from the communications module to the telecommunications network.

Advantageously, this functionality provides the manufacturer of the hand dryer appliance and/or the operator of a washroom in which the hand dryer appliance is installed, with improved visibility of when each of the hand dryer appliances in a premises will need to be fitted with a replacement filter. This can lead to the washroom operator replacing filters in advance without the filter being loaded to critical levels which may affect performance or stop the machines altogether.

In one embodiment, therefore, the system further comprises a facilities management computer system, which is configured to receive the filter loading messages and generate a maintenance request when a specific alert filter loading level has been exceeded. That system may further be configured to generate trend information based on filter loading messages and provide prediction data indicating when pre-set loading levels will be exceeded, and then to generate a filter order message based on the predicted trend information

In another aspect, embodiments of the invention provide a system comprising a hand dryer appliance having an electronic control system. The electronic control system is configured to determine a down-time period during which the hand dryer appliance has been non-operational since a previous operational period.

The determined down-time period may be used to inform various actions by the electronic control system. A trend of extended down-time periods might indicate a less popular machine, which might be due to its location. Therefore, such information could be used to flag a lower maintenance demand to a facilities management computer as part of an appliance management regime.

In another embodiment, the electronic control system may be configured to generate an alert message in response to the down-time period exceeding a predetermined down-time threshold, initiate a communications module to connect to a telecommunications network, and transmit the generated alert message from the communications module to the telecommunications network.

Advantageously, the strategy described above provides a more comprehensive approach to providing maintenance to the hand dryer appliance. Potential technical issues can be identified early, and possibly resolved by way of a simple self-test. Furthermore, maintenance requests can be logged automatically, and maintenance engineer visits can be scheduled accordingly by which means the washroom assets of the business are looked after more effectively. In addition, there are benefits also to the manufacturer of the hand dryer appliance because it can also be fed the usage data so it can gradually build up a more comprehensive picture of how its products are being used.

One option is for the electronic control system is to operate a self-test by operating a blower module of the appliance for a brief period as a check that the appliance is operating correctly. The self-test may be triggered by the appliance itself, or it may be triggered in response to a self-test command received by the appliance.

The self-test command may be transmitted to the appliance by an OEM computer system or a facilities management computer system in response to the alert message sent by the electronic control system.

In another aspect, embodiments of the invention provide a system comprising at least one hand dryer appliance and an electronic control system. The electronic control system is configured to determine a parameter set associated with the hand dryer appliance which is indicative of a cost metric for the hand dryer appliance, request user-data associated with an alternative hand drying apparatus, wherein that user data is indicative of a comparable cost metric of the alternative hand dryer apparatus, generate a usage model of the hand dryer appliance based on the determined parameter set and the requested user data, the usage model determining an operating cost metric for the hand dryer appliance and an operating cost metric for the alternative hand dryer apparatus, and generate prediction data based on the generated usage model, said prediction data indicating the point in time when the operating cost metric for the hand dryer appliance falls below the comparable cost metric of the alternative hand dryer appliance.

Advantageously, the enhanced data gathering capability of the hand dryer appliance is used to calculate when the cost of purchasing and operating the hand dryer appliance falls below the value of what it would have cost to operate a comparable hand drying solution such as paper towels or an alternative blown air hand dryer. This is a benefit for businesses that invest in such hand dryer appliances as they are able to determine in real time when their investment in the appliance or appliances is realised. This would not be feasible without the data gathering functionality of the hand dryer appliance of the invention.

By real time, it is meant that data on the usage of the hand dryer appliance is gathered by the electronic control system and used to calculate cost predictions immediately and provide these to a relevant party, for example the owner/operator of the appliance.

In this aspect of the invention, the parameter set may include a power consumption rate value associated with the hand dryer appliance and a cost of energy value associated with the hand dryer appliance.

In further aspects, the technical capabilities of the hand dryer appliance of the invention are used to provide it with a degree of ‘situational awareness’, which can be beneficial in detecting vandalism or even attempted thefts. Accordingly, embodiments of the invention provide a system comprising a hand dryer appliance having an electronic control system. The electronic control system is configured to detect an attempted theft by determining a parameter set comprising one or more appliance parameters that are indicative of the appliance experiencing an unauthorised removal condition, and to monitor the parameter set, and generate an alert message when the parameter set identifies an unauthorised removal condition. Similarly, the electronic control system is configured to detect potential vandalism of the hand dryer appliance by determining a parameter set comprising one or more appliance parameters that are indicative of the appliance experiencing a vandalism condition, monitoring the parameter set, and generating an alert message when the parameter set identifies a vandalism condition.

In either of the above cases, if an alert message is generated, then the electronic control system is further configured to initiate a communications module to connect to a telecommunications network, and transmit the generated alert message from the communications module to the telecommunications network.

By virtue of these embodiments of the invention, the hand dryer appliance has a degree of self-awareness and so can discriminate between relatively gentle nudges and background vibrations, and more severe vibrations that may be indicative of either the machine being vandalised or an attempt to remove the machine from its installation. This ability of the hand dryer appliance to monitor its integrity in this way and transmit alert messages ‘back to base’, is a particular benefit in washrooms that may be unattended, in remote locations which aren't checked regularly, or washrooms without CCTV coverage.

Various parameters may be monitored to achieve this objective. For example, acceleration values of the appliance in one or more axes would provide useful data about the movement of the appliance and the severity of that movement which could be analysed to identify an unusual vibration event that would indicate the appliance being subject to vandalism. Similarly, gyroscopic sensors could be used to infer a change in attitude/orientation of the hand dryer appliance which could suggest the appliance has been dislocated from its installed position. Furthermore, the integrity between the appliance and its mountings could be monitored by a suitable sensor, for example a Reed switch.

In either of the situations addressed above, the alert message may contain one or more data items including: appliance serial number, appliance street address location, appliance GPS coordinates, attack severity indicator.

In addition to the generated alert message, the electronic control system may also be configured to generate an audible or visual alarm indicator. This could be achieved by an audible tone or siren, flashing lights, a vocalised warning message or a combination of these measures. A further option would be for the electronic control system to trigger operation of a blower unit of the hand dryer appliance, either as a single burst or a repeated burst. The noise of operation could serve as an audible warning.

The aspects of the invention described above set out various approaches of how the hand dryer appliance is operable to monitor and report on various aspects of its own performance. However, due to the sensing and processing capability of the hand dryer appliance, it is able to provide useful technical data about other aspects of a washroom setting. In this respect, in another aspect embodiments of the invention provide a system comprising a hand dryer appliance having an electronic control system that is configured to determine the occurrence of a hand washing operation in the vicinity of the hand dryer appliance, and the duration of the hand washing operation, generate a hand washing data record based on the identification of the hand washing operation in the vicinity of the hand dryer appliance, generate a report message comprising information relating to at least the identified hand washing operation, initiate a communications module to connect to a telecommunications network, and transmit the generated report message from the communications module to the telecommunications network.

Beneficially, this approach provides the operator of the hand dryer appliance to gather useful data to monitor hygiene in the washroom. In the situation of a washroom installed in a business such as an office or a restaurant kitchen, the hand dryer appliance of this aspect of the invention is able to not only provide data on hand drying operation but is also operable to provide data about hand washing practices. This may assist the washroom operator in fulfilling reporting requirements and ensure that hygiene practices are adhered to.

Determining the occurrence of a hand washing operation may include identifying when a hand washing operation commences in the vicinity of the hand dryer appliance; and identifying when the hand washing operation terminates. Determination of the occurrence and duration of a hand washing operation may be achieved in various ways.

For example, in one embodiment the hand dryer appliance is equipped with a microphone via which it is able to monitor the ambient noise in the washroom. The microphone may be directional and so be targeted on a nearby hand washing appliance. Using a microphone, therefore, the step of determining the occurrence of a hand washing operation may comprise monitoring ambient noise and detecting the occurrence of a hand washing operation based on the monitored ambient noise. The noise may be processed to extract a noise profile, and matched or corresponded to a predetermined noise profile that is indicative of a washing operation. In this respect, a match need not be a perfect match in frequency content or otherwise in order to identify a hand washing operation.

Another option is to use visual means such as an optical sensor e.g. a camera to gather visual data and analyse that visual data to determine a hand washing operation is taking place. For example a camera associated with the hand dryer appliance may be configured to focus on an area where a stream of water would issue from the hand washing appliance. The electronic control system would then be configured to identify a presence of a water stream in the visual data and thereby identify that a hand washing operation was taking place.

As another option, the hand dryer appliance may be configured to monitor the operational status of a water valve associated with the hand washing appliance. By known the position of the valve (i.e. open or closed), the occurrence of a hand washing operation can be determined reliably.

Although the hand washing appliance may be separate from the hand drying appliance, in some embodiment the two devices may be integrated with one another into a common unit.

It should also be noted that in the above aspects, the system as defined above includes at least a hand dryer appliance and so also embraces the hand dryer appliance itself. Thus the appended claims also apply to a hand dryer appliance as comprised in the system.

Within the scope of this application, it is expressly intended that the various aspects, embodiments, examples and alternatives set out in the preceding paragraphs, in the claims and/or in the following description and drawings, and in particular the individual features thereof, may be taken independently or in any combination. That is, it should be noted that the various features of each of the aspects of the invention described above may be combined with features of the other aspects of the invention, unless those features are clearly incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

The above and other aspects of the invention will now be described, by way of example only, with reference to the accompanying drawings, in which:

FIG. 1 is a view of a system according to an aspect of the invention, the system including one or more hand dryer appliances;

FIG. 2 is a schematic plan view of a washroom facility including one or more hand dryer appliances in accordance with an aspect of the invention;

FIG. 3 is a block diagram of a hand dryer appliance in accordance with an aspect of the invention;

FIG. 4 is a representation of an appliance data record as generated by an electronic control system of the hand dryer appliance;

FIG. 5 is a representation of a maintenance data record as generated by an electronic control system of the hand dryer appliance;

FIG. 6 is a representation of a hand dryer appliance integrated with a hand washing appliance;

FIG. 7 is a representation of an operational report record as generated by an electronic control system of the hand dryer appliance; and

FIG. 8 is a graph illustrating cost metrics of alternative hand drying solutions during operation.

Note that features that are the same or similar in different drawings are denoted by like reference signs.

### SPECIFIC DESCRIPTION

A specific embodiment of the invention will now be described in which numerous features will be discussed in detail in order to provide a thorough understanding of the inventive concept as defined in the claims. However, it will be apparent to the skilled person that the invention may be put into effect without the specific details and that in some instances, well known methods, techniques and structures have not been described in detail in order not to obscure the invention unnecessarily.

In overview the invention provides a connected hand dryer system with improved technical functionality from what has so far been observed in the prior art. From a broad perspective, the connected hand dryer system comprises a network of hand dryers, or even a single ‘connected’ hand dryer, which are configured to be in electronic communication with one or more computer systems that have a role in managing the usage of those hand dryers. A first computer system may be associated with or be part of a business that owns and/or runs the facilities within which one or more hand dryers are located, for example a chain of restaurants or a service station. Such a business, i.e. a facilities management business or operator business may have an interest in various aspects of how the hand dryers under its control are used; for example, their usage rates, how they are maintained, whether any faults are present, and any consumable levels, if relevant. As such a computer system associated with that business will be referred to now on as the facilities management or ‘operator’ computer system.

A second computer system may be associated or part of a business that manufactures the hand dryers. Such a business will be referred to now on as an appliance OEM, in the sense that it is the Original Equipment Manufacturer of that appliance. As such, a computer system associated with the appliance OEM will be referred to as an appliance OEM computer system. Such a business may have an interest in how the hand dryers are used and operated, for example to analyse various performance metrics which may instruct how design improvement work could be carried out. Such a business may also provide a maintenance contract for the operator of the hand dryers, so usage data would be important in allowing the manufacturer to comply with its responsibilities.

Further features and advantages will become apparent from the discussion that follows.

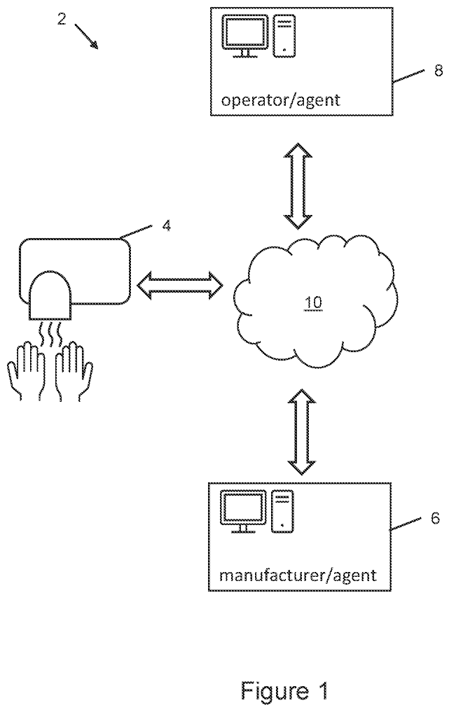

FIG. 1 illustrates from a broad perspective the main components in a system 2 according to an embodiment of the invention. In overview, that system 2 comprises one or more hand dryer appliances 4, an appliance OEM computer system 6 and an appliance operator computer system 8.

The one or more hand dryer appliances 4, the appliance OEM computer system 6 and the appliance operator computer system 8 are geographically separated from each other but are interconnected by a suitable telecommunications system 10, which may be the internet or another type of dedicated network. Therefore, each connected system is configured to communicate with one another over a suitable telecommunications protocol, such as TCP/IP, the selection of which is within the ambit of a skilled person.

The OEM computer system 6 is represented here schematically, but it should be appreciated that this is not intended to place a restriction on how that computer system would be embodied. For example, the OEM computer system 6 may be embodied by a general-purpose computer or suitable server machine at the premises of the manufacturer of the appliance, for example at the head office or a subsidiary office. In that respect, the OEM computer system 6 can be considered to provide suitable computing resources such as a processor, memory and suitable computer programs to support an operating system and suitable software that provides the requisite functionality discussed here. Equally, the OEM computer system 6 may be embodied by appropriate computing resources provided in a distributed manner, such as in the ‘cloud’. Both these and comparable options should be considered to come under the definition of the OEM computer system because it refers to a set of appropriate computing resources and functionality that is operated or controlled by the manufacturer of the appliance in question.

Similar considerations apply for the facilities management computer system 8. Here, it is presented schematically, but it should be considered to represent a computing system with the appropriate hardware and software resources to carry out the processing requirements that are included in this discussion.

The hand dryer appliance 4 is also shown in schematic form in FIG. 1. In principle the hand dryer appliance 4 could be any suitable machine that uses blown air to dry the hands of a user. For example, the hand dryer appliance could be embodied by a Dyson Airblade® hand dryer, a Dyson Airblade® Tap hand dryer or a Dyson Airblade® V hand dryer. However, whichever form the hand dryer appliance 4 takes, a key differentiator is that it is provided with appropriate computing and connectivity resources in order to communicate over the telecommunication network 10. To this end, therefore, the hand dryer appliance 4 should be considered to be a ‘connected’ device, which is equipped with a suitable hardware architecture to allow it to connect to the network 10, and to send and receive data over that network 10. Although a single hand dryer appliance 4 is shown in FIG. 1, it should be appreciated that more than one hand dryer appliance is envisaged. Indeed, it is in the context of a ‘fleet’ of such hand dryer appliances that the invention has a particular advantage.

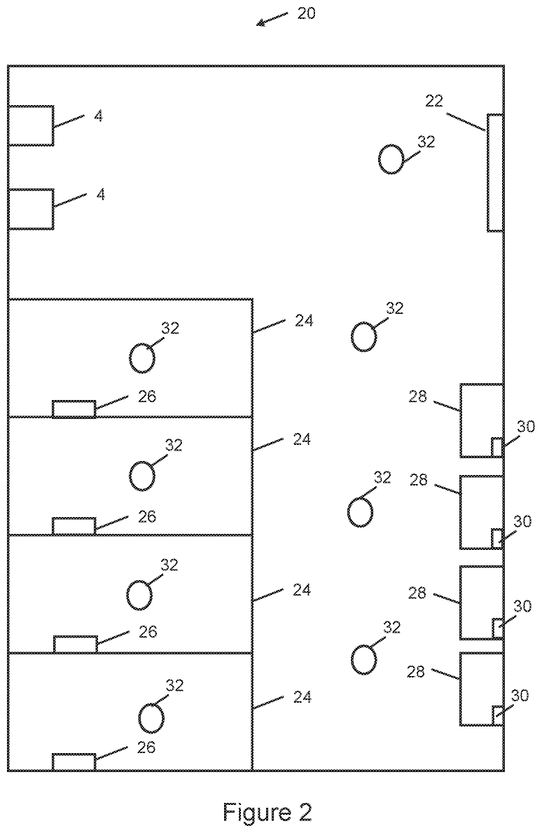

FIG. 2 illustrates a possible configuration of a ‘connected washroom’ 20 in which the hand dryer appliance 4 in accordance with the embodiments of the invention may be incorporated. Here, a pair of hand dryer appliances 4 are provided in the washroom 20 in a location opposite an entrance 22 to the washroom 20. The washroom 20 also includes four cubicles 24 each of which is provided with an associated towel dispenser 26. Facing the cubicles 24 are a row of four sinks 28, each of which has an associated tap or faucet 30. All of the aforementioned appliances may be equipped with suitable computing functionality to provide information on their usage and performance to either or both of the OEM computer system 6 and the operator computer system 8 as part of a suite of functionality for a connected washroom, so as to complement the provision of the connected hand dryer appliances 4. Distributed about the washroom 20 are a set of movement sensors 32. The movement sensors 32 provide enhanced information about the usage of the washroom 20 and make it possible to track how individuals use the washroom.

In view of the size of the washroom, it will be appreciated that it would be appropriate for a commercial setting such as a department store, station, airport or restaurant.

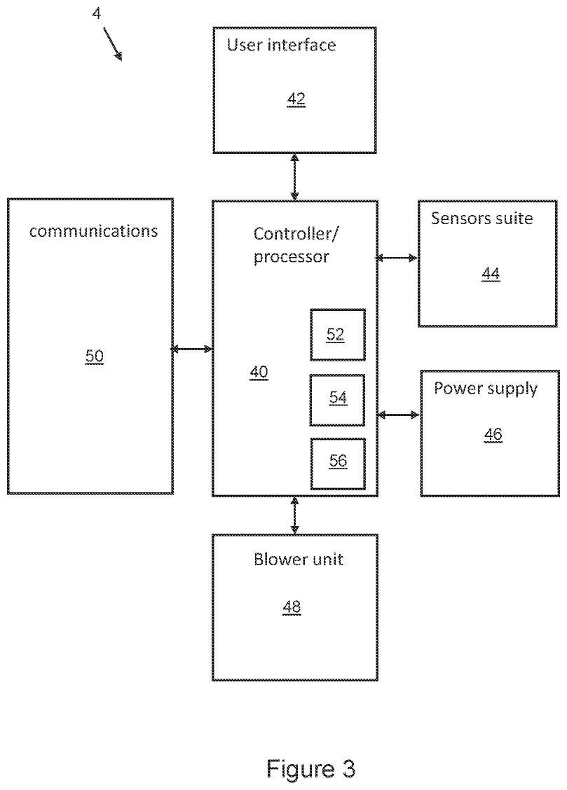

Turning now to FIG. 3, a suitable architecture for the hand dryer appliance 4 is shown. In overview, the hand dryer appliance 4 comprises an electronic control system or controller 40, a user interface 42, a sensor suite 44, a power supply 46, a blower unit 48 and a communications module 50.

The controller 40 provides the command and control system for the hand dryer appliance 4 and includes suitable hardware resources such as a central processing unit 52, memory 54 and an I/O module 56. Such items would be within the scope of the skilled person to configure in a suitable system.

The user interface 42 is the means by which a user interacts with a hand dryer appliance 4. In its most basic form, the user interface 42 may be embodied by a switch or proximity sensor in order for a user to trigger the hand dryer appliance into a hand drying operation. The duration of the hand drying operation may be determined by a preset time limit, or the user may terminate the operation by pressing the switch or moving their hands away from the proximity sensor. It is common for hand dryer appliances to start and stop based on the control of a proximity sensor to avoid direct physical contact with the user thereby improving hygiene.

The user interface 42 may also provide additional functions to a simple on/off control. For example, the user interface 42 may be at least partially be embodied as a display screen which can provide the user with any relevant information. For example, the screen could be used for delivery of advertising messages, or it could provide useful information such as air temperature, elapsed drying time and so on.

The user interface 42 may also function as a means for installation and maintenance personnel to access and configure the hand dryer appliance 4. As an example, consider the process of installing of the hand dryer appliance 4 which would require connection of the hand dryer appliance to the telecommunications network 10. This may involve configuring the hand dryer appliance 4 so that it is connected to a local area network managed by the company at which the appliance is installed. For this purpose, it may be necessary for an installation engineer to access the system settings of the hand dryer appliance 4 in order to set up the correct network credentials to enable internet access. The user interface 42 may therefore provide the necessary interfacing means such as a touchscreen to allow the required data to be entered. Further, the user interface 42 may provide a maintenance engineer with useful information to evaluate performance of the hand dryer appliance 4, whether any maintenance is needed, and whether any fault indications have been identified. With this in mind, the user interface 42 may at least in part be embodied by a mobile device (not shown) which can be configured to be in communication with the electronic control system 40, but which is remote therefrom. Such a mobile device may be a suitable laptop, cellphone/mobile phone or personal digital assistant, as would be well understood by the skilled person.

The sensor suite 44 provides the hand dryer appliance with the necessary data to analyse its performance and evaluate its ‘situational awareness’. For example, the sensor suite 44 may comprise:
airflow sensors to measure the airflow generated by the appliance;
air temperature sensors to measure the temperature of the generated airflow;
air pressure sensors to measure the pressure of the generated airflow at various positions within the machine, for example at positions upstream and downstream from the blower unit 48, and upstream and downstream from one or more airflow filters of the appliance;
acceleration sensors, to measure the various metrics relating to how the appliance is operating, for example the vibration generated by the blower unit, and more severe movement caused by outside interference such as attempted theft or vandalism.

Other suitable sensors may be visual sensors such as camera and proximity sensors, and audio sensors such as microphones, as will become apparent in this discussion.

The power supply 46 provides the hand dryer appliance 44 with the power required to operate the blower unit 48 but also its electronics equipment. Therefore, the power supply 48 may suitably be configured to provide relatively high voltage AC, for example 120V (US) or 240V (UK), to power a motor associated with the blower unit 48, but also to provide a relatively low voltage, for example 5V DC to power the various printed circuit boards that embody the hardware of the appliance. The power supply 46 is shown in FIG. 3 as being connected to the electronic control system 40, but it should be appreciated that the electronic control system 40 also controls power distribution to the other components of the system. Direct power connections between the power supply 46 and the other components may also be provided.

The blower unit 48 provides the required airflow generation for the hand dryer appliance 4 and so includes at least a motor which drives a fan, and, optionally, an airflow heater such as a wire heating element or ceramic heating element. The blower unit 48 is responsive to user on/off commands via the user interface 42 and the electronic control system 40, but may also be triggered to operate without user input, as will be discussed later.

The communications module 50 provides the hand dryer appliance 4 with the required hardware, software and firmware to connect to other electronic devices, either directly or via a network such as the internet. Therefore, the communications module 50 may provide direct device-to-device communication via Bluetooth® and NFC technology, and may provide internet connectivity via a suitable WIFI® adapter, as would be well understood by a skilled person. It is envisaged that many locations at which the hand dryer appliance 4 would be installed would be covered by a wireless communications network by which means the appliance could connect to the internet. However, in locations where such connectivity is not possible, then the communications module 50 may also provide mobile communications technology in compliance with the GSM® standards, such as 3G, 4G and 5G standards, as also would be well understood by the skilled person familiar with devices and appliance which are compatible with ‘Internet of Things’ principles.

It should be noted at this point that the functional separation shown in FIG. 3 should not be considered as requiring a physical separation of hardware modules. For example, the connectivity functionality provided by the communications module 50 may be embodied in a chip that includes sensors such as three-axis accelerometers, gyroscopes, humidity sensors and so on. Indeed, the entire functionality set as shown in FIG. 3 can be provided in a system on chip design for efficiency and robustness.

The hand dryer appliance 4 as described above, in addition to its association with the OEM computer system 6 and the operator computer system 8 may be configured to achieve certain types of functionality to result in a connected hand dryer appliance 4 that is technically enhanced in such a way that the operator of that hand dryer appliance 4 can undertake status and performance monitoring of the hand dryer appliance in order to improve its functioning and diagnose and remedy and identified problems. Similarly, the OEM computer system 6 can be configured to interact with the hand dryer appliance 4 in such a way so as to receive and collect usage data from it and other similarly configured hand dryer appliances so that the business operating the OEM computer system can take decisions to improve design and development but also to offer technical useful diagnostic capabilities which may not be possible or available to the operator of the hand dryer appliances.

Examples of such functionality will now be described.

### Product Registration

In order for the hand dryer appliance 4 to be identified as ‘live’ by the OEM computer system 6 and the operator computer system 8, the electronic control system 40 is operable to perform a product registration process automatically. The process of product registration may include the notification by the hand dryer appliance 4 of various data items to the OEM computer system 6, and also, optionally, to the operator computer system 6. Those data items should be sufficient for the OEM computer system 6 to be able to identify which hand dryer appliance has been installed and preferably also the location of the hand dryer appliance 4, the business that is operating the hand dryer appliance, to name just a few examples.

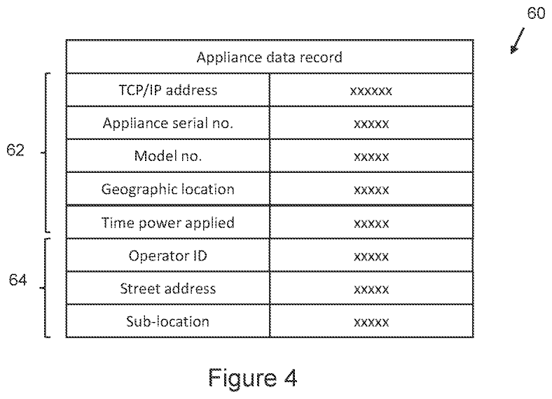

To this end, the electronic control system 4 is configured to generate an appliance data record which is loaded with one or more appliance-specific data items. An example of an appliance data record 60 is shown in FIG. 4.

The appliance-specific data items may include at least of an appliance identification data item, for example the OEM serial number of the appliance, geographical location, which may be provided by the communications module 50, the IP address of the OEM computer system, and date and time of electrical connection. These represent examples of appliance-specific data items and other data items are possible. These appliance-specific data items, which are indicated as ‘62’ in the appliance data record 60 depicted in FIG. 4, may be stored in a suitable non-volatile region of the onboard memory 54 which would be configured at the time of manufacture with the necessary data ready for the automatic product registration process.

Once the electronic control system 40 has generated the appliance data record 60, it may then initiate the communications module 50 to connect to the telecommunications network 10. For this purpose, the electronic control system 40 may require the installation engineer to provide the appliance 4 with suitable connectivity information so it can register with a local WiFi network and, thereafter, to the wider network 10. However, as an alternative, the communications module 50 may establish a direct link to the OEM computer system 6 by way of a GSM function. Once the connection to the network 10 has been established, the electronic control system 40 can transmit the appliance data record to the OEM computer system 6.

Usefully, by initiating an automatic product registration process, the OEM computer system 6 can collect information about where its products are distributed. This may help the manufacturer of the appliance understand better where maintenance resources are required so it can manage its products more effectively. Furthermore, an automatic registration process means that the operator of the hand dryer appliance 4 does not have to take a specific step to register the appliance with the manufacturer as this is done automatically by the appliance 4.

Although the electronic control system 40 may generate the appliance data record 60 automatically and also populate the data record automatically, it may also enhance the richness of the data in the data record 60 by requesting user-generated data items to complement the appliance-specific data items.

To this end, the electronic control system 40 may be configured to request one or more user-generated data items which it can then load into the appliance data record 60 ready for transmission to the network 10. One way in which the electronic control system 40 could achieve this is to provide a display prompt on the user interface 42 to request the user, in this case an engineer tasked with installing and setting up the hand dryer appliance 4 for use.

The user-generated data items, examples of which are indicated as ‘64’ in FIG. 4, may be any data that is specific to the operator of the hand dryer appliance 4. For example, such data items may include: an appliance operator identification, which could be a customer ID number associated with the operator and which identifies the operator to the manufacturer, a building location such as a postcode or ZIP code, street address or even a map reference or a What3words® codeword; and building sub-location such as a floor and/or a room location for the hand dryer appliance e.g. the identification of a washroom such as ‘Ground Floor Men's Washroom’. These are merely examples of user-generated data items and so it will be appreciated that others are possible.

As a further feature of functionality, the electronic control system 40 may be configured to transmit the appliance data record 60 also to the facilities management computer system 8. In this way, conveniently the hand dryer appliance 4 not only provides registration details to the manufacturer/OEM, but also to the facilities management business that is responsible for maintaining and servicing the appliance in the event of malfunction.

The transmittal of the appliance data record 60 may take place at any suitable time, but preferably soon after the hand dryer appliance has been installed. As one option, the electronic control system 40 may be configured to initiate the automatic product registration sequence when power is applied to the hand dryer appliance 4 for the first time during installation. This can be entirely automatic, or it could include a confirmation step during which the installation engineer is required to confirm that the product registration step should continue. Accordingly, a time stamp relating to the time and date at which power was first applied to the appliance can be included in the appliance data record 60.

### Ordering of Replacement Parts

For large businesses, the monitoring and maintenance of a large number of hand dryer appliances is a significant undertaking which can be susceptible to inefficiencies leading to increased costs. Although hand dryers are generally reliable machines, malfunctions occasionally occur and/or consumables become depleted and so it is important to an operator/owner of those hand dryer appliances to identify such conditions promptly and remedy them within a reasonable timeframe.

With this in mind, the electronic control system 40 of the hand dryer appliance of the invention may be configured to monitor its own performance and to diagnose the need for a replacement part. Following such an identification, the electronic control system 40 may be configured to transmit a request for a replacement part. This request may be transmitted to either the OEM computer system 6 so that the manufacturer can take appropriate action to send out a spare part, or the request can be made to the facilities management computer 8 which can take the appropriate action.

In order to identify a part or component that requires replacement, the electronic control system 40 is configured to monitor one or more performance metrics associated with the hand dryer appliance which are indicative of the need for a replacement part. The performance metrics may take various forms and could involve a single parameter exceeding a predetermined threshold or expected operating range, or a blend of multiple parameters which, when taken together, for example when processed by a suitable model or algorithm, indicate that a component is in need of replacement. Such a monitoring routine lends itself to predictive maintenance of the hand dryer appliance 4 which means that parts are ordered and replaced before they actually fail, which improves the efficiency of the process and avoids machine down-time.

The following are non-limiting examples of suitable performance metrics to illustrate the above concept. Firstly, airflow rate through the hand dryer appliance may be monitored by suitable air flow sensors provided in the sensor suite 44. A drop in the airflow rate from the nozzle of the hand dryer appliance 4 may indicate either that the filters are unacceptably blocked, or that the motor is liable to failure. Secondly, the motor temperature, motor speed and motor current draw may be monitored as two other metrics that are generally indicative of motor health. Therefore, if motor temperature exceeds a predetermined threshold, and/or is motor speed drops below a predetermined threshold, then it may be the case that the motor requires replacement. More simply, if the motor is not drawing current or is drawing insufficient current, then the system can infer that the motor requires replacement. In addition to discriminating parameters that exceed predetermined thresholds, the system may also infer replacement conditions from when the monitored parameters do not fall within predetermined or expected ranges, and the term ‘threshold’ should be interpreted in this context.

Such performance metrics may also indicate filter loading. For example, the electronic control system 40 may be configured to monitor the airflow rate or the air pressure either upstream and/or downstream of an air filter installed in the hand dryer appliance 4. A filter being in need of replacement may be indicated by a reduction in the airflow rate downstream of the filter and an increased pressure differential across the filter. Instead of a pressure differential metric, the metric of interest may be the air pressure upstream of the filter, the increase of which may also indicate increased filter loading. Conversely, a reduction in air pressure downstream of the filter would be indicative of filter loading.

By monitoring these parameters, the electronic control system 40 can discern that a filter replacement is required. The electronic control system 40 may also be adapted to monitor the progressive loading of the filter, which may involve the rate of increase of pressure differential across the filter. Such a filter health performance metric can then be used to trigger a maintenance action by ordering a replacement filter automatically.

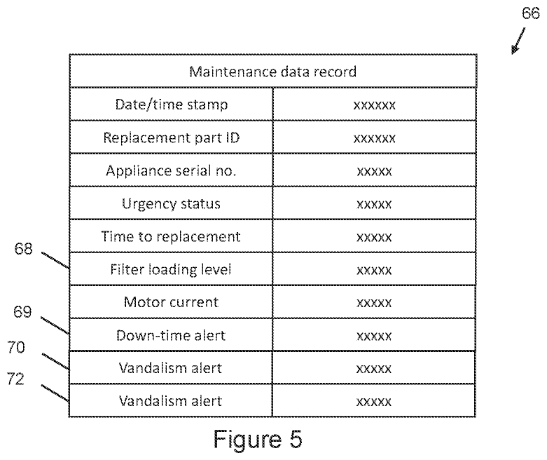

Once the need for a replacement part has been identified, the electronic control system 40 may, in response, generate an electronic maintenance record, an example of which is shown as ‘66’ in FIG. 5. Such a record at least indicates the part that requires replacement, but may also indicate further factors such as an urgency condition, or a ‘time to replacement’ parameter.

Once the maintenance record 66 has been generated, the electronic control system 40 is configured to transmit it to one or both of the OEM computer system 6 and the facilities management computer system 8 so that a suitable replacement part can be order and sent to the appropriate address so that maintenance can be carried out.

### Progressive Filter Loading

As an enhancement to the above functionality, the electronic control system 40 may also be configured to monitor progressive filter loading and report the loading level as an alternative or in addition to issuing an alert that a filter requires replacement.

One way in which may be achieved is by the electronic control system 40 generating a maintenance record 66 with appropriate data regarding filter loading level. Notably, the maintenance data record 66 in FIG. 5 has numerous fields and it should be appreciated that one or more of these fields may be populated in the maintenance data record. So, it may be the case that the electronic control system 40 only needs to report on the filter loading level, in which case it will generate a maintenance data record 66 with only the filter loading level data entry/field 68 populated in the record. In this respect, the maintenance data record 66 can be considered to be a dedicated filter loading message that is transmitted by the electronic control system over the network 10 to either or both of the OEM computer system 6 and the facilities management computer system 8.

In carrying out the above function, the electronic control system 40 is configured to monitor one or more parameters associated with filter loading performance. As an example of this, the electronic control system 40 may be configured to monitor motor speed during long term use. Motor speed is a useful indicator of filter loading, since a gradual increase in motor speed reflects a gradual increase in filter loading as the motor has to work harder to draw air through the filter to maintain an acceptable level of airflow rate.

During monitoring of the filter loading parameter, the electronic control system 40 is configured to send a plurality of filter loading messages to the OEM computer system 6 and/or the facilities management computer system 8. The plurality of filter loading messages may be sent based on different approaches. One approach is for the electronic control system 40 to send out a separate message each time the monitored filter loading parameter exceeds a predetermined threshold. For example, a separate message could be sent out each time the monitored parameter exceeds 10% loading, 20% loading, 30% loading and so on.

A second approach is for the electronic control system 40 to send out separate filter loading messages on a predetermined time interval. That time interval could be once a week, once a month, once every two months, for example. It would be within the ambit of the skilled person to determine an appropriate time interval to send the filter loading messages. The time interval between messages may not be equal. For example, the time interval may be reduced based on the level of filter loading or the rate of increase of filter loading. So, more data would be sent about the filter loading level as the filter loading increases. The advantage of this is that the OEM computer system 6 and/or the facilities management computer system 8 would be provided with more data as the filter loading level rises to more critical levels.

The OEM computer system 6 and/or the facilities management computer system 8 may act on the filter loading information in order to carry out a predicted maintenance regime. For example, when in receipt of the filter loading levels, the relevant computer system 6/8 may generate trending information to predict when the filter will need replacing. The trending information can be improved based on the more data that is received.

Advantageously, this functionality provides the manufacturer of the hand dryer appliance 4, via the OEM computer system 6, and the washroom operator, via the facilities management computer system 8, with improved visibility of when each of the hand dryer appliances 4 in a premises will need to be fitted with a replacement filter. This can lead to the washroom operator replacing filters in advance without the filter being loaded to critical levels which may affect performance or stop the machines altogether. Therefore, based on the predicted trend information, the facilities management computer system 8 can generate a filter order message and transmit this to the OEM computer system 6 so as to place an order for a replacement filter. For the manufacturer of the hand dryer appliance 4, there is provided an improved level of understanding of how filter load up during real world conditions which are problematic to test properly prior to product release. It also enables the manufacturer to gain an understanding of the need for filter so it can assess the future demand for filter so manufacturing can be geared accordingly.

### Hand Dryer Appliance Down-Time

As an enhancement of the various aspects of performance monitoring discussed above, the hand dryer appliance 4 in accordance with an embodiment of the invention may advantageously be configured to trigger a fault report to the manufacturer or the washroom operator by monitoring the amount of time that the hand dryer appliance 4 has not been operated. i.e. its “down-time”. This is based on the fact that if the hand dryer appliance has not been operated for a significant period of time, this could indicate a fault. For example, it may be an electrical fault with the machine such that the motor is unable to operate, or the user interface 42 may be broken such that it is unable to send an activation signal to the controller to power on the blower unit 48.

To this end, the electronic control unit 40 is configured in this embodiment to determine a down-time period which represents the amount of time which the hand dryer appliance 4 has been non-operational since a previous operational period. The term ‘operational period’ can be considered to mean a period during which the motor of the blower unit 48 is drawing power and generating an airflow from the appliance. So, the down-time period can be considered to be the period of time from when the motor of the blower unit 48 was last powered down.

The determination of the down-time period can be used by the electronic control system 40 in different ways. As one example of this, the electronic control system 40 may be configured to generate an alert message (see reference 69 in FIG. 5) in response to the down-time period exceeding a predetermined threshold. That threshold may be in principle any length of time, and may be configurable by the washroom operator, for example via the facilities management computer system 8, to a time period that is suitable in the circumstances. A suitable time period might be in the region of 24 hours, because it would be unusual for a hand dryer not to be used at least once during such a time period.

In response to the generation of the alert message, a self-test event or command could be generated. The self-test command would have the result of triggering operation of the hand dryer appliance for a short period to test that it is functioning correctly.

The self-test command may be generated by a sub-routine in the electronic control system 40 in which case the electronic control system 40 would react by activating the blower unit 48 itself.

Alternatively, the self-test command could be generated externally and received by the electronic control unit 40 via the communications module 50. In this case, the self-test command may be transmitted to the hand dryer appliance via the network 10 by the facilities management computer system 8 in response to the electronic control system 40 generating the alert message and transmitting that to the facilities management computer system 8.

As an alternative or in addition to generating a self-test event, the electronic control system 40 may also be configured to generate a maintenance request message 70 which is transmitted to the facilities management computer system 8. Such a message could be included in a suitably generated maintenance data record 66 in FIG. 5. In response, the facilities management computer system 8 may be configured to arrange a maintenance inspection of the hand dryer appliance 4 to ensure that it is operational.

It should be noted that the electronic control system 40 may be configured to communicate the down-time alert message 69 and the maintenance request message 70 to the OEM computer system 6 in addition or as an alternative destination to sending those messages to the facilities management computer system 8.

Advantageously, the strategy described above provides a more comprehensive approach to providing maintenance to the hand dryer appliance. Potential technical issues can be identified early, and possibly resolved by way of a simple self-test. Furthermore, maintenance requests can be logged automatically and maintenance engineer visits can be scheduled accordingly by which means the washroom assets of the business are looked after more effectively. In addition, there are benefits also to the manufacturer of the hand dryer appliance because it can also be fed the usage data so it can gradually build up a more comprehensive picture of how its products are being used.

### Usage Cost Prediction

Hand drying appliances represent an investment for a business, and the choice of hand drying solution is influenced by several different factors. Sale price is one factor, but other factors are also important such as the energy efficiency and reliability of such machines because these factors have an influence of the overall lifetime cost of installing and operating the appliances. Comparisons can be made prior to purchase about the relative costs of buying and operating one hand drying solution compared to another, but such comparisons tend to be rather theoretical and based on data that is supplied by the manufacturer or vendor of each hand drying solution. A more complete and effective way of determining the comparative cost of operating a hand drying solution would be a benefit to an operator since it would provide reliable data on the comparative energy efficiency of competing solutions, provide comparative financial information, and furthermore enable an operator to evaluate from a technical perspective competing solutions with a view to satisfying the energy efficiency targets for the business.

To this end, the hand dryer appliance 4 of the invention provides a solution to this need by virtue of its enhanced data gathering capability. As such, the electronic control system 40 is configured to determine a parameter set associated with the hand dryer appliance 4 which is indicative of a cost metric for the hand dryer appliance.

The parameter set may include one or more parameters that provide a useful representation of the cost of operating the appliance. For example, one option would be to use the parameter of energy consumption of the machine. This parameter is measurable directly by the electronic control system 40 because it has access to operational data such as the operating voltage of the system and also the current draw from the mains electricity supply. The electronic control system 40 is also configured to determine a cost of that energy. That energy cost metric may be pre-installed into the memory 54 of the electronic control system 40 or it may be obtained by other means. For example, the energy cost metric may be provided as a data input via the user interface 42 from the installation engineer. It may also be provided remotely via the OEM computer system 6 or the facilities management computer system 8 by way of a remote update.

Once the electronic control system 40 has access to the energy consumption of the hand dryer appliance 4 and the cost per unit energy (pence/cents per kWh is conventional) it is able to track its operating cost by determining how much it costs in energy terms to operate the hand drying appliance.

Thereby, by virtue of the above steps, the electronic control system 40 can be considered to determine a usage model of the hand dryer appliance because it has access to the cost of energy and the power consumption of the appliance, so it can calculate an operating cost metric as the hand dryer appliance 4 is used.

The electronic control system 40 is also configured to request user-data associated with an alternative hand drying apparatus, wherein that user data is indicative of a comparable cost metric of the alternative hand dryer apparatus. For example, a maintenance engineer, for example, may enter into the user interface 42, when prompted, a cost metric of one of a number of alternative hand drying solutions, or apparatus. For example, if the hand dryer appliance 4 is replacing a hand towel dispenser, the user may enter an average cost of hand towels that the dispenser would use over a predetermined time period, for example a day, week, month, or a longer period of time.

Since the electronic control system 40 also has access to a comparable cost metric of the alternative hand dryer apparatus, such as a paper towel solution as discussed above, the electronic control system 40 is able to predict the cost over time of using the hand dryer appliance 4 compared to the cost of the alternative hand dryer solution. Such a prediction becomes more accurate as the hand dryer appliance 4 is used since the electronic control system 40 is able to gather more data about its average power consumption. Therefore, based on the generated usage model, and knowing the purchase price of the hand dryer appliance 4, the electronic control system 40 may generate prediction data, said prediction data indicating the point in time when the operating cost metric for the hand dryer appliance falls below the comparable cost metric of the alternative hand dryer apparatus.

Expressed another way, the electronic control system 40 is configured to calculate when the cost of purchasing and operating the hand dryer appliance 4 falls below the value of what it would have cost to operate a comparable hand drying solution such as paper towels or an alternative blown air hand dryer.

The above process is illustrated in FIG. 8. As can be seen the cost of the operating cost of the hand dryer appliance starts at a purchase price ‘P’ and then increases gradually over time, due to the relatively efficient cost of operation. Conversely, the alternative hand drying apparatus, in this case being hand towels, has a cost that starts of at the origin of the graph representing a zero cost because hand towels were the previously installed solution and so do not require a capital outlay. However, the operating cost of towels are relatively high and so the cost over time increases more steeply than the comparable cost metric for the hand dryer appliance 4. At a point in time marked as ‘ROI’, the two curves intersect, which means that the cost of purchasing and operating the hand dryer appliance 4 has fallen below the comparable cost of maintain a paper towel solution, and so this represents the point at which the owner/operator of the hand dryer appliance is making a return on investment (ROI).

It should be noted that although the two lines in FIG. 8 are straight in this illustrated example, this is merely for illustration purposes and that need not be the case in practical application because average usage rates may differ between different days and weeks of the year reflecting fluctuating business periods.

A similar comparison can be made by the electronic control system 40 an alternative air blow hand drying appliance instead of paper towels. In such a case, the electronic control system 40 would request the power consumption rate of the alternative hand dryer apparatus and would therefore be able to determine a cost metric for the alternative solution based on how long the hand dryer appliance is operated.

### Vandalism and Theft Monitoring

Hand dryer appliances are usually installed in public conveniences and washrooms and so are vulnerable to being vandalised. Furthermore, they are usually expensive pieces of equipment and so they may be an attractive option for thieves, particularly if the appliances are installed in public places without much in the way of monitoring by CCTV systems.

The enhanced data processing and monitoring functionality of the hand dryer appliance 4 in accordance with the embodiments off the invention enables the hand dryer appliance 4 to be provided with a degree of ‘self-awareness’. Not only is it able to monitor its own performance and report performance-related data to the manufacturer (OEM computer system 6) and its owner/operator (facilities management computer system 8), but it is also able to apply its sensors to infer information about the integrity of its installation. This may apply particularly to vandalism and theft, where the hand dryer appliance 4 may analyse selected parameters which are indicative of either a vandalism condition that may be taking place, or a complete theft or attempted theft of the hand dryer appliance 4.

Considering firstly a situation where the hand dryer appliance 4 is subject to a vandalism condition. This may be where the hand dryer appliance 4 is struck by an object, perhaps in an attempt to damage the appliance or to remove the appliance from its mountings.

The electronic control system 40 of the hand dryer appliance 4 is able to monitor for the occurrence of such a situation by being configured to determine a parameter set comprising one or more appliance parameters that are indicative of experiencing a vandalism condition.

One option for such parameters are acceleration levels to which the hand dryer appliance 4 is subjected. The sensor suite 44 accordingly may be equipped with one or more accelerometers to monitor the vibration of the appliance.

The one or more accelerometers may be located anywhere in or on the hand dryer appliance where the acceleration may be optimally detected. One option would be for the electronic control system 40 to use accelerometers that are provided by way of ‘system on chip’ architecture, as is possible through commercially available units such as the Arduino Nano 33 IOT. These types of chip architectures are able to provide inertial sensing units that include accelerometers and gyroscopic sensors, sometimes by way of MEMS devices, that are well suited to the task. Therefore, such acceleration sensing could be provided without increased hardware requirements as would be required by separate hard-wired accelerometers.

Suitable acceleration/vibration thresholds are determinable based on experimental data of the levels of acceleration that would be experienced in various vandalism conditions. In normal use, vibration levels are expected to subsist within expected operational ranges, since vibration will be experienced through operation of the blower unit 48, through users knocking their hands against the appliance inadvertently, and also through accidental impact of people walking past. In use, therefore, once such predetermined expected ranges and thresholds are exceeded, thereby identifying a vandalism condition, the electronic control system 40 may be configured to generate a vandalism alert message, which is shown as ‘70’ in FIG. 5. Following generation of the vandalism alert message, the electronic control system 4 may connect to the network via the communications module 50 and transmit the generated alert message to the network 10. The generated alert message may either be addressed to the OEM computer system 6 or the facilities management computer system 8, based on how the electronic control system is configured when it is installed.

It should be appreciated that more than one vibration level may be used to establish respective thresholds. For example, relatively low-level vibrations may still be logged by the electronic control system 4 and reported via an alert message if appropriate. Higher vibration levels may trigger the generation of an alert message immediately. Conversely, a relatively low vibration level may trigger an alert message if it is detected as having an extended duration, for example over a few seconds, which might indicate a concerted attempt to vandalise the hand dryer appliance instead of an isolated (and potentially accidental) strike.

As part of a vandalism condition, it will be appreciated that vandalism may turn into attempted theft of the hand dryer appliance 4. This would generally be recognisable as an increase in severity of the vibrations experienced by the hand dyer appliance 4. Suitable vibration thresholds could therefore be determined by the electronic control system 40 that are indicative of a level of physical attack needed to loosen or remove the hand dryer appliance from its mounting on an adjacent wall surface. Although increased vibration levels may be one indication of a theft, other indications could be a change in the orientation or ‘tilt’ angle of the hand dryer appliance 4 because ordinarily the appliance is fixed to a wall and is immovable. Another indication could be provided by a type of proximity sensing function between the hand dryer appliance and an adjacent mounting surface. For example, a magnetic switch such as a Reed switch could be provided which is coupled between the hand dryer appliance and the wall. Dislocation of the hand dryer appliance from its mounting could trip the magnetic switch and indicate an attempted theft.

In such a situation the electronic control system 40 could be configured to monitor the selected parameters that are indicative of the appliance experiencing an unauthorised removal condition, and generate a theft alert message 72 when the parameter set identifies an unauthorised removal condition.

One an unauthorised removal condition has been identified, the electronic control system 40 may be configured to initiate a communications module to connect to a telecommunications network; and to transmit the generated alert message from the communications module to the telecommunications network for onwards receipt by either one or both of the OEM computer system 6 and the facilities management computer system 8.

As an enhancement to the generation of the vandalism alert message and theft alert message, the electronic control system 4 may also be configured to issue a visual and/or an audible alarm. This may be successful in stopping an attack immediately, or at least drawing attention to the situation. In this context, an audible alarm could be embodied by the electronic control system 40 causing the blower unit 48 to turn on, perhaps turning on and off repeatedly, without an external input.

### Monitoring of Hand Washing Time

The above discussion has covered various examples of how the hand dryer appliance 4 can be configured to monitor aspects of its own performance and infer certain courses of action that might be required. The enhanced sensing capabilities of the hand dryer appliance 4 may also be used in a wider context to provide the hand dryer appliance of how other appliances within its vicinity are being used.

For example, in the washroom environment shown in FIG. 2, the hand dryer appliances 4 share a room with sinks equipped with taps/faucets. In some embodiments, the hand dryer appliance 4 may be integrated with a hand washing system such as in the commercially available Airblade Tap. As will be described, in this embodiment the hand dryer appliance 4 is configured to monitor the operation of a nearby hand washing appliance and derive useful data.

To this end, in this embodiment of the invention the electronic control system 40 of the hand dryer appliance 4 is configured to determine the occurrence of a hand washing operation in the vicinity of the hand dryer appliance. In addition to determining the occurrence of a hand washing operation, the electronic control system 40 is configured to determine the duration of a hand washing operation.

Determination of the occurrence and duration of a hand washing operation may be achieved in various ways. For example, in one embodiment the hand dryer appliance 4 is equipped with a microphone via which it is able to monitor the ambient noise in the washroom. The microphone may be included in the sensor suite 44 of the hand dryer appliance.

The electronic control system 40 may therefore be configured to match a predetermined noise profile that is typical of a hand washing operation with a noise profile that is extracted from the ambient noise in the washroom. For example, the electronic control system 40 may be configured to take rolling ‘snapshots’ of ambient noise and apply suitable signal processing techniques such as Fourier transform analysis in order to isolate frequency content that is indicative of a hand washing operation. It is expected that a hand washing operation would typically contain relatively high frequency noise which would be appropriate for isolating by signal processing. Once a hand washing operation has been identified as taking place, the electronic control system can then monitor that hand washing operation to determine when it terminates. From that information, the control system 40 can determine the duration of the hand washing operation.

The hand dryer appliance 40 may be suitably configured to optimise its situation for capture of the ambient noise. For example, the hand dryer appliance 4 may be located adjacent or in an opposed location to a hand washing appliance so that the physical separation is not so much as to make the hand washing operation inaudible. Furthermore, directional microphones may be used and configured to target the hand washing appliance.

In an alternative, the hand dryer appliance 4 may be paired or otherwise associated with a hand washing appliance for monitoring purposes. For example, the hand dryer appliance 4 may be installed directly adjacent to the hand washing appliance so that there is a clear line of sight. In this example, although the hand dryer appliance 4 may monitor the ambient noise generated by the hand washing appliance, other sensing options become possible.

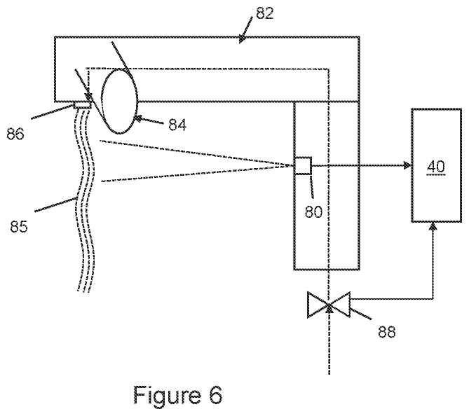

In one such embodiment the sensing suite 44 may include an optical sensor such as a camera 80 that is mounted to a hand washing appliance 82 with which the hand dryer appliance 84 is associated. Such an embodiment would be particularly suited to appliances where hand washing functions and hand drying functions are integrated into a single appliance and this embodiment is illustrated in FIG. 6 where it will be appreciated that the two appliances are integrated into a Dyson Airblade Tap®.

Here the camera 80 is oriented so that its field of view intersects a water stream 85 that exits a nozzle 86 of the hand washing appliance 82. The camera 80 is therefore usefully positioned so as to view the stream of water and feedback visual data to the electronic control system 40.

As an alternative approach for monitoring operation of the hand washing appliance 84, the electronic control system 40 may be configured to monitor operation of a water valve 88. As shown here, the water vale 80 provide a direct input to the electronic control system 40 as to its operational position, which is either open or closed. The electronic control system 40 is therefore able to measure accurately when a hand washing operation is started and when it is stopped.

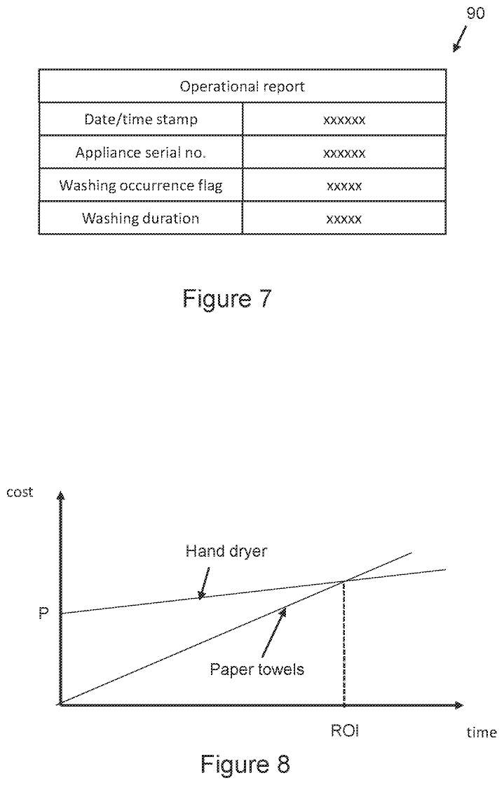

Once the electronic control system 40 has detected the occurrence of a hand washing operation and the duration of a hand washing operation it is configured to generate an operational report record or message 90, an example of which is shown in FIG. 7.

As shown in FIG. 7, the operational report record 90 may include suitable data to enable the hand washing operation to be correctly identified and logged. So, as is shown here, the data entries may include a data/time stamp of the hand washing operation, the appliance serial number which detected the hand washing operation, a flag that a hand washing occurrence has been identified, and a time value of the hand washing duration.

Once the operational report record has been generated, the electronic control system is configured to establish a link to the network 10 and to transmit the operational report message 90 to the network 10 suitable addressed to the OEM computer system 6 and/or to the facilities management computer system 8.

1. A system comprising:
a hand dryer appliance comprising an electronic control system and a filter;
wherein the electronic control system is configured to:
monitor a filter loading parameter that is indicative of a loading level of the filter;
generate a plurality of filter loading messages over time based on the monitored filter loading parameter, indicating the progressive loading of the filter,
initiate a communications module to connect to a telecommunications network; and
transmit the generated filter loading messages from the communications module to the telecommunications network.

2. The system of claim 1, wherein the system further comprises a facilities management computer system, which is configured to receive the filter loading messages and generate a maintenance request when a specific alert filter loading level has been exceeded.

3. The system of claim 2, wherein the facilities management computer system is configured to generate trend information based on filter loading messages and provide prediction data indicating when pre-set loading levels will be exceeded.

4. The system of claim 3, wherein the facilities management computer system is configured to generate a filter order message based on the predicted trend information.

5. The system of claim 1, wherein the plurality of filter loading messages comprise data items including: filter loading level, time stamp, motor current draw.
